(19) United States
(12) Patent Application Publication
(10) Pub. No.: US 2012/0175368 A1
(43) Pub. Date: Jul. 12, 2012

(54) LUER SEAL FOR SOLID PHASE EXTRACTION COLUMNS

(75) Inventors: Philip A. DIMSON, San Pedro, CA (US); Bruce Redmond, Clairemont, CA (US)

(73) Assignee: SPEWare Corporation, Baldwin Park, CA (US)

(21) Appl. No.: 13/346,044

(22) Filed: Jan. 9, 2012

Related U.S. Application Data
(63) Continuation of application No. PCT/US2010/041115, filed on Jul. 6, 2010.

(51) Int. Cl. H02G 3/14; B23P 11/00; B23P 19/00

(52) U.S. Cl. 220/241; 29/700; 29/428

(57) ABSTRACT

Disclosed herein is a luer seal for sealing a bottom outlet of each of the wells or columns in a plurality of Solid Phase Extraction (SPE) wells or columns in an array, the luer seal comprising a flexible, substantially flat mat having a top surface and a bottom surface, the top surface having portions defining a plurality of female luer slip connectors spaced for receiving an open tip of at least one of the plurality of solid phase extraction wells or columns, and sealingly fastening thereto for preventing fluid flow through the open tip. Also disclosed is a luer seal extractor for removing the luer seal from the column tips substantially simultaneously.

### RELATED APPLICATIONS

This application is a continuation of International Application No. PCT/US2010/041115, which designated the United States and was filed on Jul. 6, 2010, published in English, which claims priority to U.S. Provisional Patent Application No. 61/223,708 filed on 8 Jul. 2009. The entire teachings of the above applications are incorporated herein by reference.

### FIELD OF THE INVENTION

The disclosed invention relates to devices and methods for Solid Phase Extraction (SPE).

### BACKGROUND OF THE INVENTION

Solid Phase Extraction (SPE) is a sample preparation process using chromatographic micro columns for the extraction of nonvolatile or semi-volatile analytes from a liquid sample. SPE is often used for the preparation of liquid samples prior to performing quantitative chemical analysis, for example, via high performance liquid chromatography (HPLC), or gas chromatography (GC). SPE can also be used to separate solids that have been previously extracted into solvents.

Using SPE, target analytes can be isolated from a complex sample containing compounds that may interfere with the performance of a quantitative analysis, producing a solution that contains the target analyte, and that is free of potentially interfering substances. This solution can then either be used for quantitative analysis or be further concentrated. For example, prior to using high performance liquid chromatography (HPLC) to analyze a sample such as plasma or urine, insoluble matter and soluble interferences in such a biological sample are generally removed using SPE. The SPE also pre-concentrates target compounds in the sample for enhanced detection sensitivity.

A typical SPE tube is a cylindrical micro column or housing often formed from polypropylene or glass, and having a top inlet and a bottom outlet. The SPE micro column is packed with a particulate medium referred to as a “sorbent,” a “resin,” a “solid phase,” or an “extraction phase,” terms which are used herein synonymously and interchangeably. The bed of sorbent is packed between two porous frits, made, for example, of polyethylene, polypropylene, Teflon, or stainless steel. A typical pore size of the frits is 20 micrometers (20 μm).

An SPE column with packed sorbent is pre-conditioned, typically with water and methanol using gravity, vacuum or positive pressure.

A liquid sample is first prepared in a container such as a test tube. To the test tube is added sample, buffer and an internal standard. The sample mixture is then transferred into the pre-conditioned SPE column. The sample fluid is typically poured in through the top inlet of the SPE column; the sample flows through the top frit, through the pre-conditioned sorbent, through the bottom frit, which is close to the bottom outlet, out the bottom outlet, and into a collection container. The fluid flow may be achieved by gravitational force, or by reduced pressure or vacuum applied at the lower end of the SPE column.

An SPE device may be in a single column or a multi-well format. Typical multi-well formats include 12, 24, 48, and 96 well or column array. Alternatively, the SPE micro column and a collection container may be placed in a centrifuge and centrifugal force used to cause the sample fluid go flow through the sorbent.

The choice of sorbent is based on which sample components are to be retained on the sorbent. In SPE at least one substance in a mixture of substances is initially adsorbed on the sorbent. A sample is loaded onto a pre-conditioned sorbent. Then a sequence of elution fluids are passed through the sorbent in the column to separate interferences from the target analytes in the sample. For example, the removal of interferences such as unwanted molecules from the target analyte may comprise adhering such interfering compounds to the sorbent and allowing target analytes to remain in solution and elute through the column. In other cases, the target analytes adhere to the sorbent, and the interfering compounds are washed or eluted through the column. Following removal of the interfering compounds, a different solvent is used to remove the target analytes from the sorbent and to elute the target analytes through the column.

Traditional SPE columns do not have covers at the tips. Once the columns have been pre-conditioned with water and methanol, any sample placed in the column reservoir immediately begins to flow through the column by capillary action and gravity. With a multi-well format, it is difficult to obtain uniform processing of the columns because the flow of sample through the columns will begin at different times, making automating the SPE process more difficult.

Samples must be placed in a test tube first before they are transferred into a conditioned SPE column. An automated liquid handler can then be used to transfer a sample from a test tube into a SPE column. In processing a batch of 48 or 96 samples, the first samples that are transferred into the SPE columns start flowing immediately. By the time the automated liquid handler transfers the last sample into the last column, the first sample has completely run through the first column. Thus, one serious problem with use of currently available batch processing techniques into SPE devices (multi well and multi column) is that the samples are not processed identically. Another ongoing problem with these same devices is that the SPE columns having the earlier-poured samples tend to dry out before the later samples are poured.

Medical diagnosis and treatment increasingly require identifying and quantifying metabolites and drugs in biological fluids; and this has led to an increased need for high throughput, automated bioanalytical systems, including multi-column SPE devices. Because sample preparation time remains a rate-limiting step in automated systems, there is a need for decreasing sample preparation time for multi-column SPE set-ups. There also exists an on-going need for a device and a method that achieve uniform processing of multi-column SPE arrays, including keeping all the columns of a multi-well SPE device conditioned until all the columns are prepared; keeping the poured samples in the columns intact; and beginning the flow through each of the multi-well columns in the array substantially simultaneously.

### SUMMARY OF THE INVENTION

In accordance with the present invention there is provided a device and method that can decrease sample preparation time and also eliminate the above-described problems by providing uniform processing of multi-well and multi column SPE columns. The inventors of the disclosed subject matter have now developed a luer seal device for use with both a multi-well and a multi column SPE apparatus. The disclosed luer seal is designed to maintain conditioning of the columns for the SPE process, and to maintain the samples intact within the columns until the user is ready to elute the samples through the columns. The disclosed device and method provide for the flow of samples through each well or column of a multi-column SPE array of columns to begin substantially simultaneously.

Disclosed herein is a luer seal for sealing a plurality of solid phase extraction wells or columns in an array, the luer seal comprising: a flexible, substantially flat mat having a top surface and a bottom surface, the top surface having portions defining a plurality of female luer slip connectors spaced for receiving an open tip of at least one of the plurality of solid phase extraction wells or columns, and sealingly fastening thereto for preventing fluid flow through the open tip.

### BRIEF DESCRIPTION OF THE DRAWINGS

Embodiments of the invention are further described hereinafter with reference to the accompanying drawings, in which:

FIG. 1 is a schematic trans-sectional front elevational view of a 96 well SPE column device with attached SPE luer seal according to an embodiment of the invention.

FIG. 2 is a perspective view of a 96 well SPE column device in a 96 well SPE column holder showing a V-tab according to an embodiment of the invention.

FIG. 3 is a perspective view of a 96 well SPE column device in a 96 well SPE column holder showing SPE column luer tips, and SPE luer seal mat according to an embodiment of the invention.

FIG. 4A is a top plan view of a SPE luer seal mat according to an embodiment of the invention.

FIG. 4B is a front elevational view of a SPE luer seal mat according to an embodiment of the invention.

FIG. 4C is a side elevational view of a SPE luer seal mat according to an embodiment of the invention.

FIG. 5A is a front elevational view of a sealed SPE column holder with columns and SPE luer seal pressed onto the bottom of the SPE column luer tips according to an embodiment of the invention.

FIG. 5B is a front elevational view of a luer seal extractor according to an embodiment of the invention, the luer seal extractor shown with a sealed SPE column plate and ready to remove the SPE luer seal.

FIG. 5C is a side elevational view of a luer seal extractor according to an embodiment of the invention, the luer seal extractor shown with a sealed SPE column plate and ready to remove the SPE luer seal.

FIG. 5D is a cut-away top plan view of a luer seal extractor according to an embodiment of the invention, showing the extractor slide and direction of movement thereof needed to remove the luer seal from the SPE column plate.

### DETAILED DESCRIPTION

A description of preferred embodiments of the invention follows. It will be understood that the particular embodiments of the invention are shown by way of illustration and not as limitations of the invention. At the outset, the invention is described in its broadest overall aspects, with a more detailed description following. The features and other details of the compositions and methods of the invention will be further illustrated in the claims.

The inventors of the present subject matter have discovered an apparatus and method for providing a means for improving the automated processing of SPE samples; for allowing the sorbent in multiple SPE column devices to remain conditioned for a much longer time period than that possible with prior art devices; and for allowing multiple samples, for example, a 96 well column array to be processed identically. A “column” as the term is used herein, refers to either an SPE micro-column or well, or a larger SPE column. The disclosed invention relates and applies to any SPE device that is used to direct liquid flow through the output of the column. As such, this tip is typically referred to as a “luer tip,” but the invention is not limited to a standard luer design. Various embodiments of the disclosed luer seal can be used, for example, with small tips typical of a pre-molded set of 96 wells.

A male luer connector, in general, has a tapered outer surface; and a female luer connector has a complementary tapered inner surface. The tapering allows for connectors that are not precisely dimensioned to sealingly mate for either fluid transfer or to provide a seal to prevent fluid flow through a channel. Luer connection systems have been previously used, for example, in medical devices for attaching two pieces of tubing to one another. For example, a luer connector may be used to attach tubing to a syringe, a catheter, or an IV tube. The term “luer connector” is generally known by those of skill in the medical arts and chemical engineering arts, for example, as a connector that includes male and female rounded interlocking tubes, generally slightly tapered, so that the tubes fit together more securely. A luer connection can be a simple pressure fit, referred to as a “luer slip” connector. Alternatively, a “luer lock” connector provides a more secure fit, requiring a push and twist together motion for the connection. A luer lock may have an outer, threaded rim that requires a twisting motion in order to seal, for a twisted or “screwed together” fit.

As stated above, currently available SPE columns do not have covers at the column tips. Thus, any sample placed in the column immediately begins to flow through the column, making it difficult to process columns in a multiple-column array uniformly.

As disclosed herein, we have invented a device that treats the column tips of an SPE multi-column array as male luer slip connectors. We have invented a luer seal mat that is applied to the bottom of the array after the SPE columns have been pretreated. The luer seal mat remains in place until the columns are ready for the elution step. At that time the mat is peeled off the block and the columns are placed on a collection vessel for elution. This same concept also can be applied to any size column array and any arrangement including, but not limited to, the 96 column array of one exemplary embodiment, or a 48 column system that generally utilizes larger columns than used in the 96 well array, and is configured in a four by 12 (4×12) array.

Our invention relates generally to a device that allows a rack of 48 SPE columns or 96 SPE columns that have been pre-conditioned, to be covered by a mechanical seal at the tapered or male luer end of each SPE column. The 96 well format consists of 96 SPE columns in an 8×12 array. In one embodiment of the invention, for example, a molded silicone rubber mat includes a plurality of spaced female luer slip connectors integral with the top surface of the mat, and spaced such that the female luer slip connectors can be aligned with the male luer column tips and press-fit onto the bottom of the array of columns, such that all 96 luer tips are sealed at the same instant. This seal creates a compressible air gap between the SPE sorbent bed and the tip of the luer end of the column. Placed on the output end of the column, the luer seal mat prevents any solvent from flowing through the column, and allows the sorbent within the column to remain conditioned.

Thus, the entire column can act as a container for actually preparing the sample prior to the SPE separation. This feature eliminates or minimizes the rate-limiting aspect of the sample preparation step in high throughput processing. It does so by enabling the user to use automated liquid-handling equipment to add the sample, the buffer and the internal standard directly into the SPE cartridge, without any of the sample passing through the sorbent bed and dripping from the bottom of the column.

Once all the samples have been added to the columns, the SPE luer seal mat can then be peeled off all of the luer tips, substantially simultaneously, either by directly pulling the luer seal mat off the column tips, or by using a luer seal extractor as described below. The entire rack or plate is placed over a collection container or a waste bin.

The luer seal extractor is a device that supports or cradles the sealed SPE plate or rack, and in one embodiment has a keyed slide with a built-in hook. As the user pulls the slide out, the hook catches a “V” tab that hangs down from the SPE luer seal. This single-hand motion allows the user to effortlessly remove the SPE luer seal completely without disturbing the column samples.

The quick removal of the SPE luer seal mat provides the user sufficient time to put the SPE rack or plate over a reservoir or a waste bin before the sample liquid begins to drip or flow through the column. Because the disclosed device provides a system and method for the quick removal of all the luer seals substantially simultaneously, the liquid will begin to flow in all of the columns substantially simultaneously, thereby ensuring more uniform processing of the columns than is possible with prior art devices.

### The Luer Seal Mat

As disclosed herein, the inventors of the present subject matter have now invented a mechanical sealing device for simultaneously sealing a multiple well array of SPE columns. In one embodiment of the invention, the mechanical seal comprises a flexible, substantially flat mat, referred to herein as the “SPE luer seal mat,” having a top surface and a bottom surface, and a plurality of spaced female luer slip connectors integral with the top surface thereof.

In a preferred embodiment, the SPE luer seal mat is constructed of an elastomeric material, for example, silicone. In one embodiment, the SPE luer seal mat is a molded silicone rubber mat. An “elastomer” or an “elastomeric material,” as these terms are used and understood by those of skill in the relevant arts is any one of a various polymers having the elastic properties of natural rubber. The disclosed SPE luer seal may be constructed of a resilient material. “Resilient,” as the term is used herein, refers to that property of a material that enables it to resume its original shape or position after being stretched, compressed, or bent. Elastomeric and resilient, as the terms are used herein, have similar meanings.

Non-limiting examples of other materials that may be suitable for use in constructing the SPE luer seal mat according to an embodiment of the invention include a polyester, a polypropylene, a perfluoroelastomer, a fluoroelastomer, a neoprene, a polyurethane, fluorosilicone, and combinations thereof. Some suitable commercially available elastomeric materials for the SPE luer seal matt include VITON® (Du Pont de NeMours & Co., Delaware; a fluoroelastomer); HYTREL® (Du Pont de NeMours & Co., Delaware; a polyester elastomer); and AFLAS® (Asahi Glass Co., Limited, Tokyo, Japan; a heat and chemically resistant fluoro rubber.)

The elastomeric material may be coated with a thin jacket of a chemically resistant material such as polytetrafluoroethylene or fluorinated ethylene propylene (FEP). The combination of a chemically resistant polymer jacket over an elastomer provides an outer layer of protection against corrosion combined with the memory of an elastomer when put under a compressive force. When the wall of the tubular portion of the female luer slip connector comprising an elastomer is compressed by the force of the column tip inserted in the female luer slip connector, the resilience of the elastomer provides a good seal for the column tip.

FEP is a highly inert plastic, having low permeability to liquids, gases, moisture and organic vapors; non-flammability; high resistance to solvents; excellent anti-stick and low-frictional properties; and resistance to impact and tearing. Almost any FEP encapsulated or coated elastomeric material is suitable for use as the disclosed SPE luer seal mat.

In one embodiment of the invention, the SPE luer seal mat, has a maximum thickness of from about 0.002 inch (about 0.0051 centimeter) to about 0.250 inch (about 0.635 cm). In another embodiment of the invention, the flexible, substantially flat luer seal mat has a maximum thickness of about 0.080 inch (about 0.203 centimeter).

In one embodiment of the invention, a luer seal for sealing a plurality of solid phase extraction columns in an array comprises a flexible, substantially flat mat having a top surface and a bottom surface, the top surface having portions defining a plurality of female luer slip connectors spaced for receiving an open tip of at least one of the plurality of solid phase extraction columns, and sealingly fastening thereto for preventing fluid flow through the open tip.

In one embodiment of the invention, each of the female luer slip connectors of the disclosed luer seal has a tubular portion comprising: a proximal end having an annular opening at the top surface of the mat, the annular opening sized to accept the open tip of the solid phase extraction column and sealingly fasten thereto; and a closed distal end, and wherein the tubular portion is substantially perpendicular to the top surface of the mat.

The disclosed female luer slip connectors each comprise a substantially cylindrical channel having an inner annular surface and a diameter sized to matingly engage with the outer surface of the SPE column tip, which column tip serves as the male luer slip connector. In one embodiment of the luer seal mat, the opening of the tubular body of each female luer slip connector has an approximate diameter of about 0.150 inch (0.381 cm) to fit the outside diameter of about 0.381 cm that is typical for a standard male luer tip of a micro column. The channel of the female luer slip connector may be slightly tapered.

The female luer slip connectors on the SPE luer seal matt are spaced to match the position of the SPE column tips in the SPE multiple column array, which may be, for example a 96-well or a 48-well set of columns held in a 96-well or a 48-well column holder.

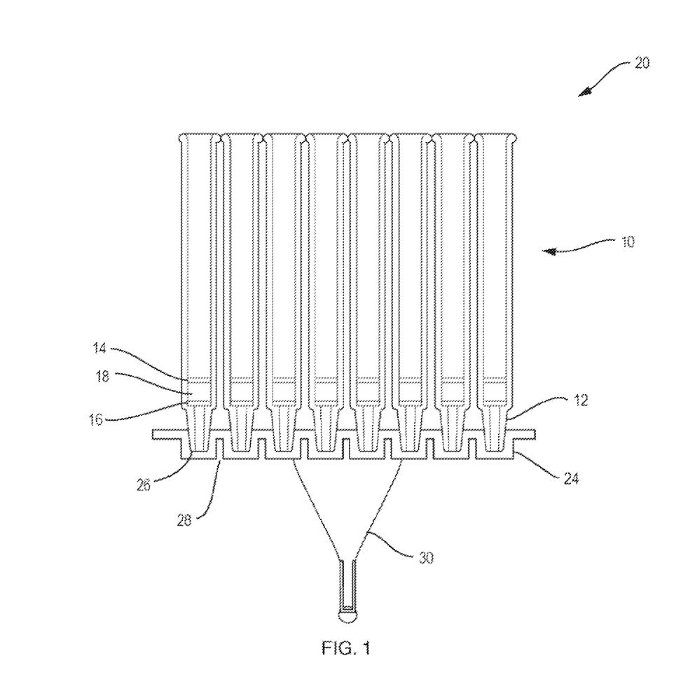

Turning now to the figures, FIG. 1 is a schematic trans-sectional front elevational view 20 of a 96 well SPE column device with attached SPE luer seal 24 according to an embodiment of the invention. The SPE multi-well column array comprises 96 SPE columns 10 in an eight column by 12 column (8×12) array. FIG. 1 shows that each column 10 has a first filter fabric 16 and a second filter fabric 14 inserted within, and a sorbent bed 18 packed between the first and second filter fabrics 16, 14. As shown, each column 10 has, below the first filter fabric 16, a slightly tapered, SPE column luer tip 12 having a slightly tapered internal bore.

FIG. 1 shows the channels comprising the spaced SPE female luer slip connectors 26 on top surface of SPE luer seal mat 24, the SPE female luer slip connectors 26 engaging the SPE column tips 12 to seal the columns 10.

As shown in FIG. 1, the channels are the tubular portion of the female luer slip connector 26, and have a slightly tapered shape, wherein the proximal end has a larger diameter than the diameter of the distal end, such that the female luer slip connector 26 can form a press-fit with the open tip 12 of the solid phase extraction column 10, and sealingly fasten thereto. In one aspect, the SPE column tip 12 functions as a male luer connector body having an external male luer tapered shape. As shown in the figures and as described above, the SPE female luer slip connector 26 has an internal female Luer tapered shape substantially conforming to the external shape of the SPE column tip 12. Because the SPE luer seal mat 24, as described above, is constructed of an elastomeric material, the SPE female luer slip connector 26 is capable of sealing the open SPE column tip 12 against fluid flow therethrough because the elastomeric material is biased against the open tip.

FIG. 1 depicts the SPE luer seal mat 24 press-fit onto the bottom of the array, having sealed all 96 SPE column luer tips 12 at substantially the same time. Each column 10 as shown has an air gap within the SPE column luer tip 12.

This SPE luer seal mat 24 is applied to the bottom of the array after the SPE columns 10 have been pretreated, and remains in place until the columns 10 are ready for the elution step. Also shown are the channels 28 that are spaces between the tubular bodies of female luer slip connectors 26 on the bottom surface of luer seal mat 24. The bottom surface of the SPE luer seal mat 24 comprises the closed distal end of the tubular portion of at least one of the plurality of spaced female luer slip connectors 26.

In one embodiment of the invention, the luer seal includes an uncoupling means 30 attached to the flexible, substantially flat mat 24 for use in removing the luer seal from the array of solid phase extraction columns 10. In FIG. 1, the uncoupling means includes a V tab 30 attached to luer seal mat 24. The uncoupling means can be used to pull the luer seal mat 24 off of all the SPE column luer tips 12 at substantially the same time when the columns 10 are ready for the elution step in processing.

Non-limiting examples of the uncoupling means 30 include may be chosen from a tab, a V-tab, a loop, a handle, a hook, and combinations thereof. Any means of connecting the luer seal mat 24 to a mechanical device for pulling the luer seal mat 24 off of the SPE column luer tips 12 is envisioned as being within the scope of the disclosed invention. The mechanical device may also be activated by a human hand.

As stated above, each column 10 as shown has an air gap within the SPE column luer tip 12. Upon disengagement of each female luer slip connector 26 on the luer seal mat 24 from the SPE column luer tip 12, a partial vacuum is formed within the SPE column luer tip 12, the partial vacuum drawing any fluids within the column 10 through the SPE column luer tip 12. The configuration of the disclosed SPE column luer seal mat 24 comprising an array of SPE female luer slip connectors 26 spaced to correspond to the positions of the array of the SPE columns 10 and an uncoupling means 30, enables the SPE operator to disengage each of the SPE female luer slip connectors 26 from the corresponding SPE column luer tips 12 substantially simultaneously, thereby allowing the fluid flow through each column to begin at approximately the same time, and all the columns 10 in the array to be processed substantially uniformly.

### The Luer Seal Extractor

The means for moving the uncoupling means of the luer seal in a direction such that the luer seal is removed from the array of solid phase extraction columns may include a mechanical device. One embodiment of such a mechanical device includes a rail or other elongated support mounted on the inside bottom surface of a hollow housing; a slidable element, slidably mounted on the rail, the slidable element comprising a portion configured to engage the uncoupling means of the luer seal when the slidable element is in a first position, and to pull the luer seal away from the tips of the plurality of solid phase extraction columns in an array when the uncoupling means is moved in a direction parallel to the bottom surface of the mat to a second position.

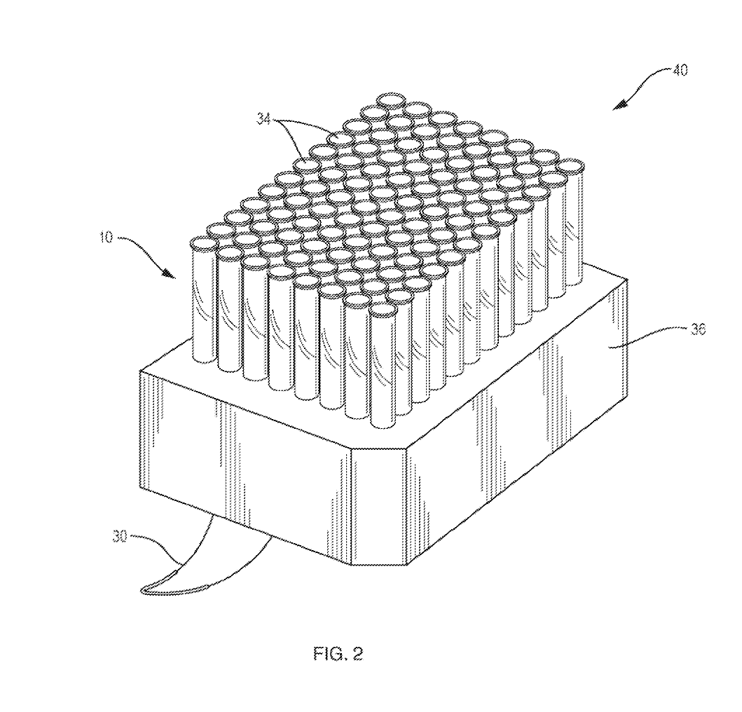

FIG. 2 is a perspective view of a 96 well SPE column device 40 in a 96 well SPE column holder 36 showing the uncoupling means as a V-tab 30 according to an embodiment of the invention. The array of columns 10 is supported by a 96 well column holder 36. The column top opening 34 for receiving a fluid sample is shown.

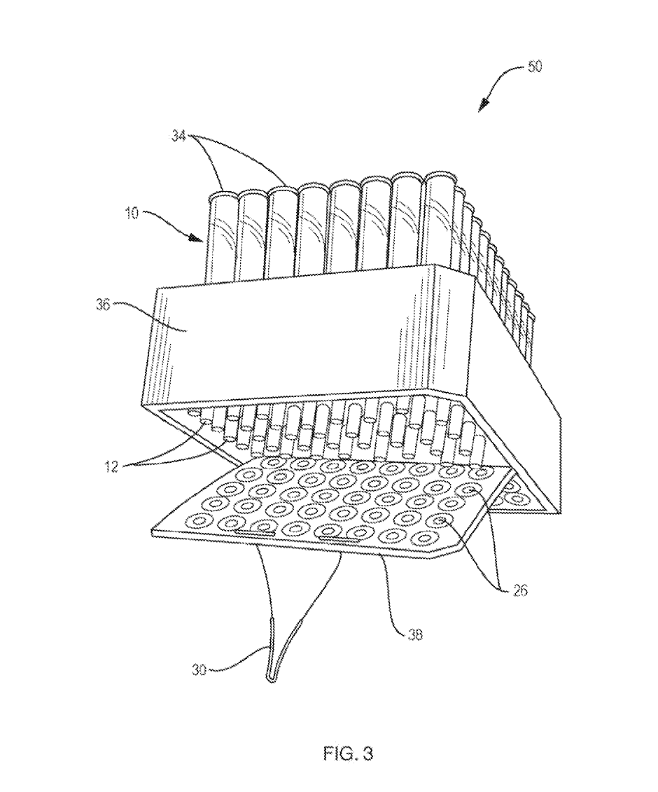

FIG. 3 is different perspective view of a 96 well SPE column device 50 in a 96 well SPE column holder 36 showing SPE column luer tips 12 in the open bottom of the holder 36, and SPE Luer seal mat 38 with integral, spaced SPE female luer slip connectors 26 according to an embodiment of the invention. SPE Luer seal mat 38 is shown partially disengaged from the column tips 12.

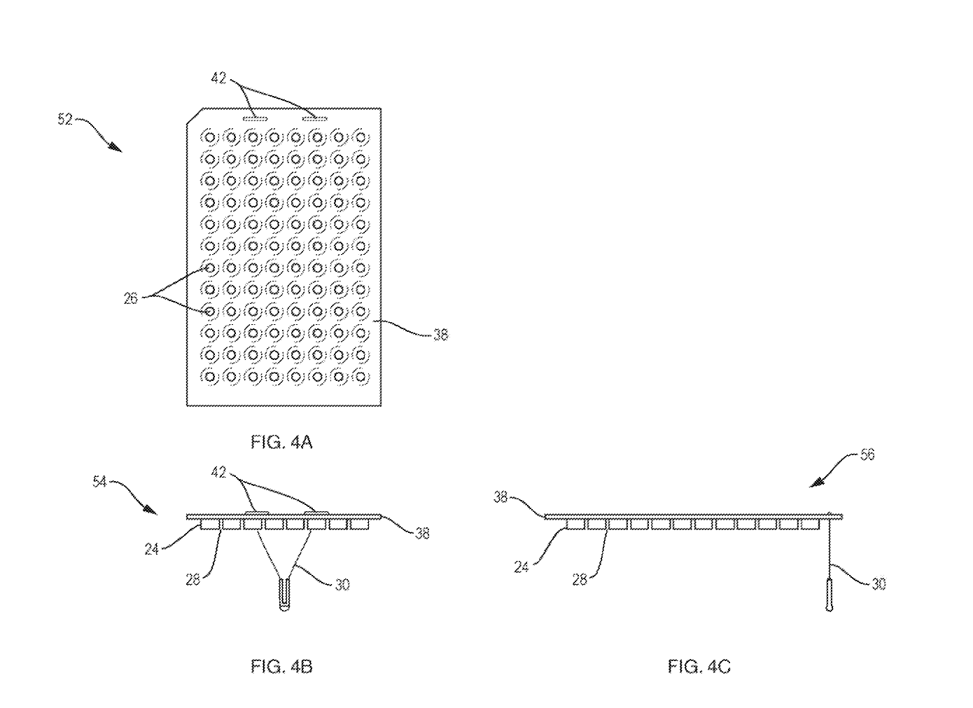

FIG. 4A is a top plan view 52 of a SPE Luer seal mat 38 showing a V-tab attachment 42 according to an embodiment of the invention.

FIG. 4B is a front elevational view 54 of a SPE Luer seal mat 38 with V-tab attachment 42 according to an embodiment of the invention. The spaces or channels 28 between the tubular bodies of the SPE female luer slip connectors 26 allow for expansion of the elastomeric material of the tubular body of the SPE female luer slip connector 24 such that it can form a tight seal with the column tip 12.

FIG. 4C is a side elevational view 56 of a SPE Luer seal mat according to an embodiment of the invention.

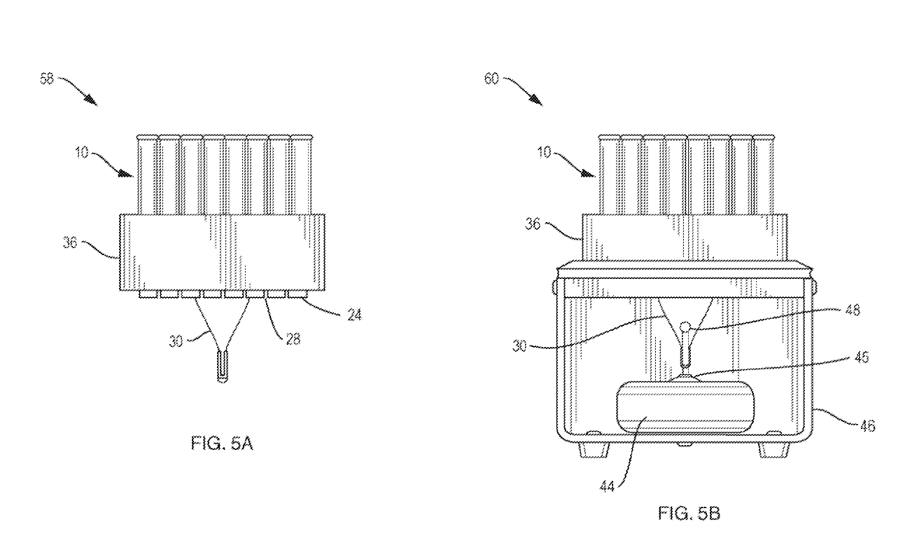

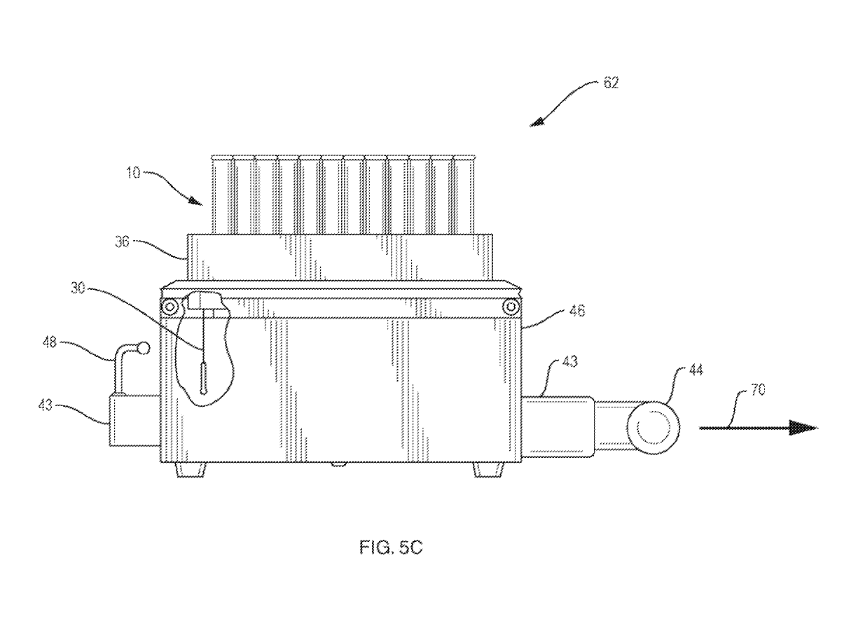

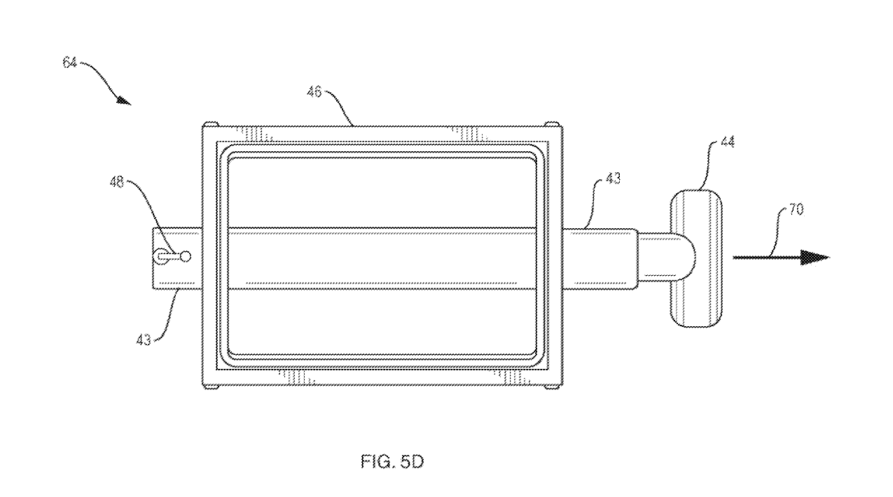

FIG. 5A is a front elevational view 58 of a 96 well SPE column holder 36 with sealed columns 10 and SPE Luer seal 24 pressed onto the bottom of the SPE column Luer tips (not shown) according to an embodiment of the invention.

FIGS. 5B through 5D depict another embodiment of the invention which includes a luer seal extractor for removing a luer seal from the tips of a plurality of solid phase extraction columns 10 in an array.

FIG. 5B is a front elevational view 60 of a Luer seal extractor according to an embodiment of the invention, the Luer seal extractor shown with a sealed SPE column array 10 supported by a column holder 36, and ready for the SPE Luer seal (not shown) to be removed. The luer seal extractor 60 in the embodiment shown includes a hollow housing 46 having an inside top surface and an inside bottom surface, the housing 46 configured to support the 96 well plate column holder 36. The luer seal extractor 60 includes a means for moving the uncoupling means 30, which in the embodiment shown is a V-tab 30, of the luer seal in a direction such that the luer seal is removed from the array of solid phase extraction columns 10.

The luer seal extractor 60 shown in FIG. 5B includes a slide (not shown in this frontal view) with a slide handle 44, and a connector means, which in the embodiment shown is a hook 48 which is connected to or engaged with the V-tab 30 at the opposite or back end of the extractor 60. The hook 48 is fixedly attached to the back end of the slide at the hook attachment point 45.

FIG. 5C is a side elevational view 62 of a luer seal extractor according to an embodiment of the invention, the luer seal extractor 62 shown with a sealed SPE column plate 10 and ready to remove the SPE luer seal (not visible).

In FIG. 5C, the luer seal extractor 62 is shown with a partial cutaway of the luer seal extractor housing 46 to show the V-tab 30 of the SPE luer seal mat 24. The extractor slide 43 is shown with its hook 48 mounted on the back portion of the extractor slide 43. When the slide 43 is pulled forward toward the front of the extractor device 62, in the direction of motion indicated by arrow 70, the hook 48 engages the V-tab 30 and pulls, removes, or disengages the SPE luer seal mat from all the column tips substantially simultaneously and smoothly, without disturbing the columns. Slide handle 44 facilitates the movement of slide 43, and can be grasped by the operator's hand or moved by attaching to a motive device.

FIG. 5D is a cut-away top plan view 64 of a luer seal extractor according to an embodiment of the invention, showing the extractor slide 43 and direction of movement 70 thereof needed to remove the luer seal from the SPE column plate. The luer seal extractor housing 46 is shown. The column holder is not shown. The hook 48 attached to the back end of the slide 43 is shown.

In one embodiment, the luer seal extractor slide 43 is made of an aluminum shell extrusion, and a polypropylene T-Handle 44 is fastened to the front end of the slide 43 and a stainless steel hook 48 is fastened to the top-rear end of the slide 43. The slide 43 in one embodiment is a shell extrusion shaped to ride on a polyethylene rail (not shown) that is attached to or molded with the bottom of the luer seal extractor housing 46. The rail guides the slide 43 and positions it in the correct starting position. As the user pulls the slide 43 out in the direction shown by arrow 70, the hook 48 catches the “V” Tab 30 that hangs down from the SPE luer seal mat 24, and removes the luer seal mat 24 from the column tips 12 substantially simultaneously.

In another embodiment of the invention, a “phase layer” of material is placed in the column before the column is packed with the sorbent. This layer of material will not allow liquid to pass thru unless the column is under pressure. Non-limiting examples of a phase layer suitable for use in an embodiment of the invention include a membrane film or layer of pourous TEFLON® or polypropylene; and a membrane layer that functions as a duck bill type closure on the column that is molded from silicone rubber or similar polymers.

Among the advantages provided by our invention is a means for maintaining the columns and the samples intact until the user is ready to push the samples through the columns. Our Invention eliminates this problem because it keeps the columns conditioned for the entire process and keeps the samples intact until the user is ready to push the samples through the columns.

Another advantage described above is that our disclosed device allows the columns to serve as containers for actually preparing the sample prior to the SPE separation. This feature eliminates or minimizes the rate-limiting aspect of sample preparation.

### EQUIVALENTS

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A luer seal for sealing a bottom outlet of each of the wells or columns in a plurality of solid phase extraction wells or columns in an array, the luer seal comprising:
a flexible, substantially flat mat having a top surface and a bottom surface, the top surface having portions defining a plurality of female luer slip connectors, each of which has a tubular portion comprising:
a proximal end having an annular opening at the top surface of the mat, the annular opening sized to accept an open tip of the bottom of the solid phase extraction well or column and to sealingly fasten thereto; and
a closed distal end, and wherein the tubular portion is substantially perpendicular to the top surface of the mat, the plurality of female luer slip connectors configured for receiving the open tip of the bottom of at least one of the plurality of solid phase extraction wells or columns, and sealingly fastening thereto for preventing fluid flow through the open tip.

2. (canceled)

3. The luer seal of claim 1, wherein the tubular portion of the female luer slip connector has a tapered shape, and wherein the proximal end has a larger diameter than the diameter of the distal end, such that the female luer slip connector can form a press-fit with the open tip of the bottom of the solid phase extraction well or column, and sealingly fasten thereto.

4. The luer seal of claim 1, further comprising an uncoupling means attached to the flexible, substantially flat mat, the uncoupling means configured for use in removing the luer seal substantially simultaneously from the entire array of solid phase extraction wells or columns.

5. The luer seal of claim 1, wherein the bottom surface of the mat comprises the closed distal end of the tubular portion of at least one of the plurality of spaced female luer slip connectors.

6. The luer seal of claim 1, wherein the flexible, substantially flat mat comprises silicone rubber.

7. The luer seal of claim 1, wherein the flexible, substantially flat mat comprises a material chosen from: a polyester, a polypropylene, a perfluoroelastomer, a fluoroelastomer, a neoprene, a polyurethane, fluoro silicone, and combinations thereof.

8. The luer seal of claim 1, wherein the flexible, substantially flat mat has a maximum thickness of from about 0.002 inch (about 0.0051 centimeter) to about 0.250 inch (about 0.635 cm).

9. The luer seal of claim 1, wherein the flexible, substantially flat mat has a maximum thickness of about 0.080 inch (about 0.203 centimeter).

10. The luer seal of claim 4, wherein the uncoupling means is chosen from a tab, a V-tab, a loop, a handle, a hook, and combinations thereof.

11. A luer seal extractor for removing the luer seal according to claim 4 from the tips of a plurality of solid phase extraction columns in an array, the luer seal extractor comprising:
a hollow housing having an inside top surface and an inside bottom surface, the housing configured to support the array of solid phase extraction columns in an upright position; and
a means for moving the uncoupling means of the luer seal in a direction such that the luer seal is removed from the array of solid phase extraction wells or columns.

12. The luer seal extractor of claim 11 wherein the means for moving the uncoupling means of the luer seal in a direction such that the luer seal is removed from the array of solid phase extraction wells or columns comprises:
a rail mounted on the inside bottom surface of the hollow housing;
a slidable element, slidably mounted on the rail, the slidable element comprising a portion configured to engage the uncoupling means of the luer seal when the slidable element is in a first position, and to pull the luer seal away from the tips of the plurality of solid phase extraction wells or columns in the array when the uncoupling means is moved in a direction parallel to the bottom surface of the mat to a second position.

13. A method of improving automation of a solid phase extraction process in a plurality of solid phase extraction wells or columns in an array, the method comprising:
providing the luer seal mat of claim 1, and a plurality of solid phase extraction wells or columns in an array, each of the plurality of solid phase extraction wells or columns having an open tip at the bottom thereof;
sealingly fastening the proximal end of each of the plurality of female luer slip connectors of the luer seal mat to the open tip of the corresponding solid phase extraction well or column to which the female luer slip connector is configured for receiving, thereby sealing the open tips at the bottom of the plurality of solid phase extraction wells or columns and preventing a flow of a sample or a solvent through the well or column;
maintaining the luer seal mat sealed in place for a period of time sufficient to add the sample or the solvent to each of the plurality of solid phase extraction wells or columns, and to prepare the samples prior to the solid phase extraction, while preventing any of the sample or the solvent from flowing through the wells or columns and draining out of the open tips of the wells or columns until the wells or columns are ready for elution; and
peeling the luer seal mat off all of the well or column tips substantially simultaneously, thereby enabling a flow of the sample or the solvent through the plurality of wells or columns to begin at substantially the same time; providing a uniform processing of the sample in each of the wells or columns; and
improving automation of the solid phase extraction process.

14. The method of claim 13, wherein the sorbent within each of the columns or wells is allowed to remain conditioned until performing a simultaneous elution of all the columns or wells.

15. The method of claim 13, wherein a luer seal extractor is used to peel the luer seal matt off all of the well or column tips, substantially simultaneously.
